(19) United States
(12) Patent Application Publication
(10) Pub. No.: US 2012/0185779 A1
(43) Pub. Date: Jul. 19, 2012

(54) Computer System and Method of Audience-Suggested Content Creation in Social Media

(75) Inventors: Casey Dugan, Winchester, MA (US); Werner Geyer, Newton, MA (US); Scott H. Prager, Stratham, NH (US)

(73) Assignee: INTERNATIONAL BUSINESS MACHINES CORPORATION, Armonk, NY (US)

(21) Appl. No.: 13/088,191

(22) Filed: Apr. 15, 2011

Related U.S. Application Data
(60) Provisional application No. 61/432,440, filed on Jan. 13, 2011.

(51) Int. Cl. G06F 3/048; G06F 3/00

(52) U.S. Cl. 715/739; 715/733

(57) ABSTRACT

A computer based system and method of audience-based suggestion for content creation in social media is disclosed. The content suggestor system and method receive user requests including title of content that the requester would be interested in viewing/reading. The system routes the request to any number of target users that would be likely to responsively create/upload such content, including both users the requester has deemed appropriate as well as any the system deems appropriate. A user interface displays topic requests to the target users (users the request was routed to). Upon content being uploaded in the global computer network in response to the request, the system notifies each requesting user. The content responsively created and uploaded may be in media different from the medium of the initial request.

### CROSS REFERENCE TO RELATED APPLICATION(S)

This application claims the benefit of U.S. Provisional Application No. 61/432,440, filed on Jan. 13, 2011.

The entire teachings of the above application(s) are incorporated herein by reference.

### BACKGROUND

Social Media, such as blogs, social bookmarking systems, social networking sites, etc., allow users to upload and share valuable content and knowledge with their colleagues (in Enterprise deployments) and the world (on the Internet or global computer network). And while many are avid users of such systems, there always exist adoption issues. There are classes of users who:

visit such systems once and never return,

visit and upload content very infrequently,

upload small amounts of content,

upload only certain kinds of content (not making use of all features, etc.),

use the system for a period of time then stop, and

never visit a first time.

Additionally, when such systems are deployed within Enterprises, they face a “cold start” problem. Before end-user generated content is contributed, there is little value in going to these systems a first time. Also, there can be cultural and organizational barriers which inhibit adoption, such as when users are not sure what is appropriate or valuable to share with others.

### BRIEF SUMMARY

The present invention provides a topic-suggestion system and method that effectively inspires potential content authors (users) by connecting them with their audience. According to one embodiment of the present invention, a method and system for audience-suggested topics for content creation (or audience-based requests for content creation) in social media, in a global computer network, comprises:
Step 1: users (requester) submitting a title and, optionally, description of the content (and possibly medium/media) they would be interested in viewing/reading,
Step 2: the system routing this request to any number of people (target users) that would be likely to create/upload such content, including both those the requester has deemed appropriate in the previous step as well as any users that the system deems appropriate,
Step 3: the system displaying the topic requests to the target users (users the request was routed to) in an appropriate interface, and
Step 4: when a response to a request is created/uploaded in any social media system, the invention system notifying the requester of that (and each) response.

Applicants' system seeks to encourage the creation/upload of content in social media systems by allowing the “audience” to make requests for content they would like other users to upload. The requests may be questions on a topic, invitations or call for opinions on a subject and other inspiration for content (what to post), and optionally in which medium/media forms (a bookmark, a video/photo, blog) to post subject content (where and how to post). These requests for content are then routed and recommended to users who are likely to upload such content. Any number of the people who receive the request, as well as any others who discover the request through other means (posted “recent requests” list, “popular requests” list, etc.), are able to respond by uploading/creating the appropriate content. The requester(s) are then notified for example by an email alert. Additionally, in order to capture the interest of a larger group of people, users are able to “vote” on requests, thereby specifying that they too would be interested in reading/viewing such content if it were uploaded. Finally, at any time, any user can forward any request to another user they believe would be interested in/able to upload such content.

There are a few key differentiators from Question and Answer sites, where users are allowed to pose questions and others are allowed to post answers (such as Yahoo Answers™).

First, Applicant's route requests to those likely to upload/create the content requested (i.e., a would-be-author of content). This is done through a variety of possible means, for example distributing to the social network of the requester, the social network of any additional voters, those found through a content-matching algorithm. Additionally, the requester/voters are allowed to manually specify individuals (or characteristics of individuals, such as job title “Sales”) of the people who the request should be forwarded to.

Second, unlike the answers in a Question and Answer system, the responses to requests in the current invention are stored in third-party social media/sharing systems with pointers to those responses. For example, if the response is in the form of a blog entry, the entry lives in a blogging system (on a blog of the answering user), if the response is a bookmark, it lives in a social bookmarking system (on a page of the answering user). The media of the response is allowed to be different than the medium of the original request. Further, rather than responding with one type of media, there could be multiple types of responses, as in the bookmark and blog entry examples.

Finally, Applicant's system and method allow users to vote on requests made by others, indicating their interest in seeing/reading others' responses to that request. While Question and Answer systems allow multiple answers to a single question, these systems do not allow others to vote on the question itself, though typically those systems allow votes/ratings on the answers provided. In this way, the present invention makes it possible for a would-be-content author to see “questions” or requests where a potential answer/response is valuable to a larger group of people and choose to give those questions/requests priority in answering/responding.

Thus embodiments motivate content creation and connect online authors with their audience. In turn, such systems and methods of the present invention effectively (a) support knowledge sharing and collaboration across communities of users, (b) capitalize on relationship between authors and readers (consumers) of information, and (c) encourage creation of content that meets the needs of information consumers.

In one embodiment, an audience-suggested content creation method and system comprise:

in a computer network, obtaining a topic request submitted by a requester user, the topic request indicating a topic for content that the requester user is interested in viewing;

using a processor, routing the topic request to any number of target users that would be likely to responsively create such content including any users that the requester user has indicated;

displaying the topic request to the target users in an interface operatively coupled to the processor; and

notifying at least the requester user at each instance of content being uploaded to the computer network in a response to the topic request.

The topic request as submitted by the requester user may include any combination of: a title of the topic, a description of the topic and an indication of media for the requested content.

The uploaded content in response to the topic request is viewable by other users in addition to the requester-user. That is, the uploaded content is uploaded to a non-private medium and in a non-individual user targeted communication. For non-limiting example, the uploaded content in response to the topic request is any of a blog entry, a bookmark, a Wiki, a web page entry, a web page posting, a photograph posting and an online video posting. Further, the uploaded content in response to the topic request is uploaded by a target user to a social media system of the target user's choosing.

Embodiments enable the requester user to indicate target users by any of: individual name, occupation title and part of a social network (such as group or social category).

Embodiments enable more than one response to the topic request. Where multiple different content is uploaded by different users in response to the topic request, at least the requester user is notified for each content upload.

Embodiments enable a user in the computer network to vote on the topic request. The notifier then includes notifying each voter user of each instance of content uploaded in response to the topic request. Further, the display includes an indication of a total number of users interested in the topic request, the total number being a sum of voter users and requester user of the topic request.

In one embodiment, the user interface display includes any of:

enabling a user to selectably see details about a voter user's interest in the topic request; and

indicating to a certain recipient of the topic request, an individual voter user's stated interest in the certain recipient responding to the topic request. The user interface display may include indicating to a given target user one or more reasons why the topic request was routed to him.

In some embodiments, the user interface enables other users to view the topic request without having had the topic request directly routed to them. The user interface may enable target users and other users of the computer network to forward the topic request to one or more users. Other embodiments further enable a target user to see the topic request routed to his social network; and enable that target user to indicate which individuals in his social network are likely to respond to the topic request.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network in which embodiments of the present invention are deployed.

FIG. 2 is a block diagram of a computer node in the network of FIG. 1.

FIG. 3 is a flow diagram of one embodiment of the present invention.

FIGS. 4 through 6 are schematic views of a user interface in one system embodying the present invention.

### DETAILED DESCRIPTION

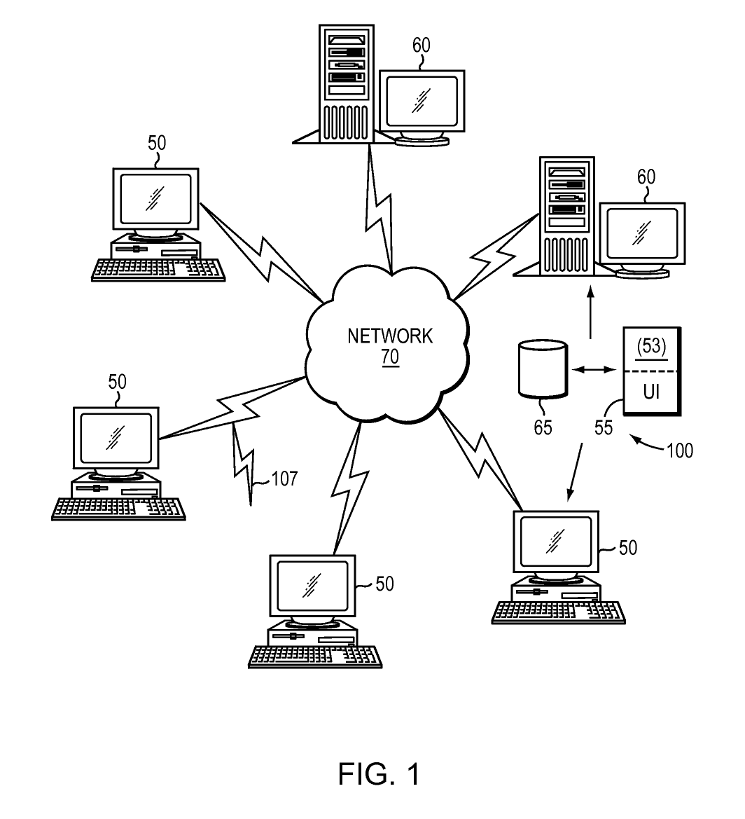

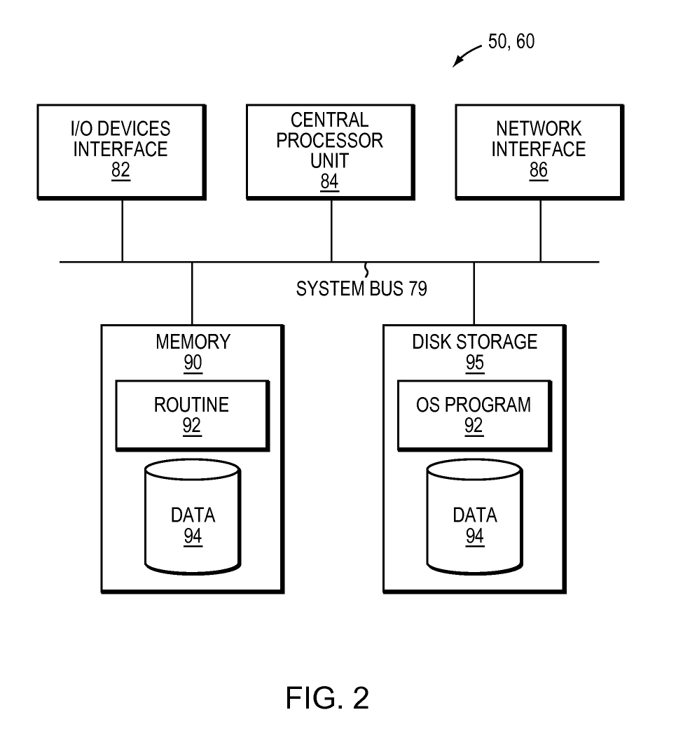

With reference now to FIGS. 1 and 2, a description of various embodiments is given.

In a non-limiting example scenario of embodiments of the present invention, a product manager user requests information on “Selling Software M in the Pharmaceutical Industry.” In response, system 100 routes this request to the product manager's social network, those with an interest in the pharmaceutical industry, and sales people for Software M. System 100 enables other users to indicate that they too would be interested in reading/learning about such a topic, through a “vote” feature. If a salesperson this request was routed to then writes a blog entry on “Selling Software M in the Pharmaceutical Industry” in response to this request, system 100 notifies the original product manager user as well as any others who “voted” on this topic about the blog entry. In addition, if someone who saw the original request recommended the topic to an additional person interested in the medical industry, who also chose to write a blog entry on the topic, then system 100 responsively notifies the product manager user and other “voters” about that resulting entry as well.

While one embodiment is within a blogging system (i.e. a user requests a blog entry about X, another user responds to the request by writing a blog entry about X), the system 100 may be generalized to allow for responses in other kinds of social media (other medium and form). For example, in the scenario above, those users to whom the product manager's request was routed could have responded with:

a bookmark related to “Selling Software M in the Pharmaceutical Industry”, rather than a blog entry, or

a slide deck related “Selling Software M in the Pharmaceutical Industry”, or

a community of people who currently sell Software M in that industry, or

a Wiki entry related to “Selling Software M in the Pharmaceutical Industry”, or

a response to a discussion forum question related to “Selling Software M in the Pharmaceutical Industry”, etc.

FIG. 1 illustrates a computer network or similar digital processing environment in which the present invention system 100 may be implemented. Reader based content suggestion system 100 includes a topic requester or recommendation unit 53, a corresponding user interface 55 and recommendation queue 65 (each further detailed later).

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., topic requester 53, topic request router processing, user interface 55, additional features and supporting code/logic of system 100 detailed below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In a non-limiting example embodiment, system 100 implements the following. If users want to read online about a certain topic but cannot find any online content (e.g., blogs, videos, white papers, Wiki's etc.) about that topic, they use the invention content suggestion system 100 (in particular, the topic requestor or recommender unit 53) to interact with other users (would be content authors) and ultimately have pertinent content created and uploaded. To accomplish this, one example embodiment of system 100 operates as follows.

Step 1: Users (requesters) submit to system 100 a title of a topic or subject matter and, optionally, a description of the content (and possibly media form for the content) they would be interested in viewing or reading. Users may also optionally specify the name(s) of any users they think would be particularly interested in or knowledgeable about that topic or likely to upload such content. The user may also explicitly specify that his/her social network (or any subset) be routed this request. The user may also explicitly specify that users with matching keywords, etc., be routed this request. The user may also explicitly specify any other user-matching criteria for routing this request (e.g. “direct this request to people in Sales” or “direct this request to GBS employees in Massachusetts”). Known user interface, web portal page and/or other dialogue page technology and techniques may be utilized to implement this step.

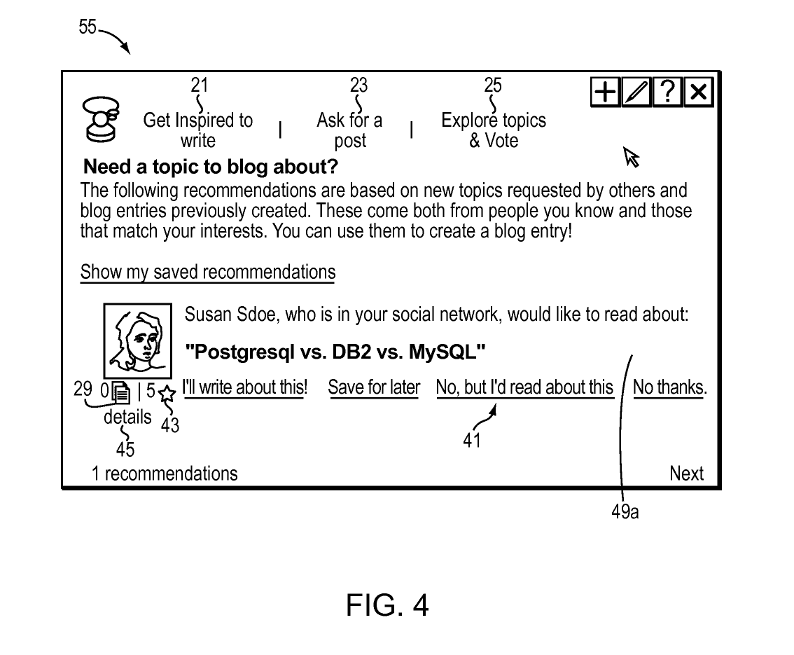

Optionally, the requesting user may specify the mediums that he would like to see the responding content in. As an example, the request 49 (FIGS. 4-6) may indicate “I would like a bookmark about . . . ” or “I would like a photo of . . . ” or “I would like a blog entry about . . . ”.

Step 2: Responsively, the system 100 routes this request 49 to any number of people (target users) that would be likely to create/upload such content, including both those the requester has deemed appropriate in the previous step as well as any the system 100 finds and deems appropriate. This could include those in the requester's social network, those with matching keywords, etc. Common content-based and network-based techniques for determining recipients (matching topics and users) are employed. Common techniques for routing the requests 49 to those recipients are employed.

Step 3: System 100 displays the topic requests 49 to the target users (recipient users the request was routed to) in an appropriate interface 55. The interface 55 may include for example, a notification about the topic request 49 via email, or a list presentation of topic requests on a website and the like.

Step 4: When a recipient user, target user or other user creates and uploads a response to the request 49, system 100 notifies at least the original requester of that response. Common notifier and/or alert technology along with subscription type techniques are employed. Each responding user uploads respective created content to a media system and is in a form of his choice, including, but not limited to, an entry in his blog, a bookmark in a shared online bookmarking service/system, a video in a social networking site, an article at his page in a social networking site, etc.

The system 100 and routing process make possible a detailed explanation of why a particular recipient/target user was routed a given topic request 49. In addition to merely presenting a given topic request to a recipient/target user, system 100 enables display to the user the reasoning the system 100 used to route the request to him/her. These reasons could include, but are not limited to:

If a topic requester directly specified particular user(s) in Step 1 of the process, the explanation could be “[Requester's name] would like you to write/create/upload . . . [topic requested]”;

If a user was routed a topic request because he/she was in the requester's social network, the explanation could be “[Requester's name], who is in your social network, would like to read about . . . [topic requested]”;

If a user was routed a topic request 49 because he/she was a content-match for the topic, the explanation could be “[Requester's name], would like to read about the following which matches your interests”.

Additional Features:

More than one response to a given topic request 49 is possible. In the case of multiple responses, system 100 notifies the requester of each response whether it be a blog, a bookmark, a Wiki, a web page posting, an on-line video system entry, or other non-private medium entry/posting of content.

Other users beside the requester can see responses to the requested topic. This is due to the system 100 enabling the responses to be provided via a non-private medium and in a communication type that is not individualized to the requester-user, in contrast to an email message or chat session of prior art.

Users can also discover topic requests 49 that have been generated in system 100 through a variety of means. For instance, users can see requests 49 that were not explicitly routed to them by the system 100 where system 100 posts for general viewing lists of popular requests, recent requests, and your social network's requests, etc.

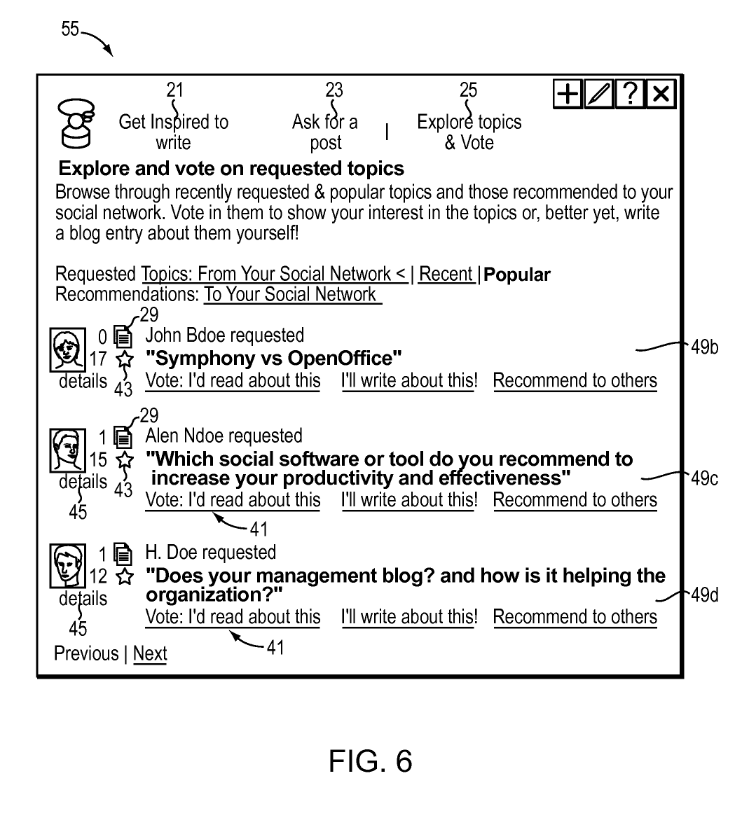

System 100 enables users to vote on a topic request 49 to indicate that they would also be interested in reading/viewing content created/uploaded in response to this request. In turn, in addition to the original requester, the system 100 maintains a list of or otherwise tracks all those who indicate their interest in a topic request 49 through the vote mechanism 41 (FIGS. 4 and 6). Using the tracking list, system 100 also notifies the other indicating (voting) users when responses to a request 49 are created (uploaded). Such notification is accomplished in one embodiment by system 100 using subscription technology to configure the original requester user and the voting users (the tracking list of users) as subscribers to the topic request 49 and to the responses to the topic request 49.

System 100 enables users to forward an existing topic request 49 (including those created by others or discovered through other means) to a plurality of other users by specifying those users. System 100 utilizes common or known forwarding request or other request delivery techniques.

In some embodiments, system 100 provides to users the ability to see a topic request 49 routed to one or more users in their social network and to vote on whether they believe that certain one(s) of the one or more users is likely/able to respond to that request.

The voting mechanism 41 further enables the following features. System 100 enables displaying to a user who is routed the topic request 49 the total number of users interested in reading about a given request. System 100 displays this total number in other places in the interface 55 where a topic request 49 is displayed/discoverable. The total number may be defined by number of requester(s) plus the number of voters (that is, requesting users and voting users).

Further system 100 may include the total number of interested users in the detailed explanation (reasons) presented to a user that the topic request 49 was routed to, i.e. “18 people would like to read about the following topic . . . . ” In some embodiments, system 100 displays more (additional) detailed information about each voting user who indicated his interest in reading about a given topic. The additional detailed information may include when (e.g., date and time) the voting user indicated his interest, etc.

The ability to vote on topics recommended to those in one's social network makes possible refining or improving the detailed explanation (reasons) provided to the user who was routed the topic request 49. The refinement may be from an explanation (reason) such as “[someone] would like to read about the following . . . ” to “[user by name who voted] would like you to write about the following . . . . ”

FIGS. 4-6 show a sample user interface 55 illustrating the foregoing features.

In one embodiment, the user interface 55 has three primary tabbed views:

a “Get Inspired to Write” tab 21 (FIG. 4)—where users can see topics recommended to them by the system,

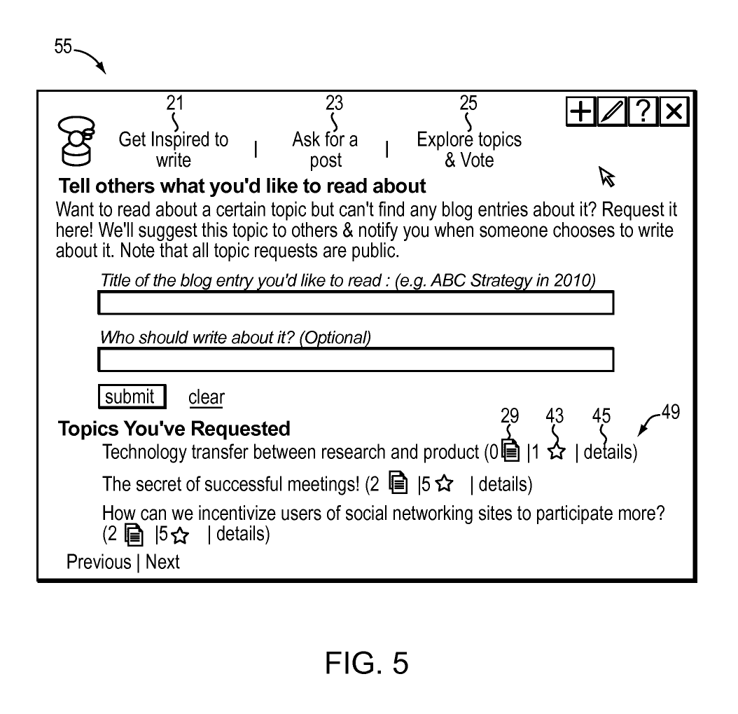

a “Ask for a Content Post” tab 23 (FIG. 5)—where users can request topics from the community, and

an “Explore Topics and Vote” tab 25 (FIG. 6)—where users can see existing topic requests 49b, c, d (generally 49) for example in categories of recent, popular, or topics from a user's social network.

In the “Get Inspired to Write” view 21 (FIG. 4), a target or recipient user can scroll through the topics the system 100 has recommended or requested of that user in the form of topic requests 49a (generally 49) and take the following actions on them. The target/recipient user can write about the topic. He can save a topic request 49 and write about it later. He can decline but specify that he would read a content post about this topic. This adds another vote (through voting mechanism 41) to the topic request 49 and results in the user being notified if another user later writes about this topic. Or he can decline the recommendation/topic request 49. From this view 21, the target user may also get back to any recommendations/topic requests 49 that he has saved and take among the same actions on those. If a target user decides to write about a topic indicated by a topic request 49, system 100 opens a dialog which allows authoring and publishing content using a rich text editor. The content can also be saved to a blogging or other publishing system as a draft. Application or system linking, API and other pertinent techniques are utilized.

In one embodiment, topic requests/recommendations 49 are ranked in the “Get Inspired to Write” view 21. User requested topics preferably get ranked higher than topics matched from existing content entries (also referred to as recycled topics) if any. Since the creation of user-requested topics is beyond system control, i.e., dependent on users requesting topics, the user requested topics get inserted on the fly at the top of the recommendation queue 65 (FIG. 1) of a target user whenever a new topic request 49 is entered into the system 100 and routed to that user. If no user-requested topic is available, the interface 55 optionally shows topic recommendations that are pre-computed and matched based on existing topics. For example, for a given user, the existing topics (“recycled entries”) optionally shown are either previously written about by the user's social network, i.e., network matched (“[user] who is in your social network, wrote about the following”), or matched to the user's keyword profile using a TF-IDF (Term frequency-Inverse document frequency) score and cosine similarity, i.e., content-matched (“[user] wrote about the following, which matches your interests/keywords”).

Within user-requested topics, direct requests 49, where a user was directly specified by the requester at the time of the request, are ranked highest in the “Get Inspired to Write” view 21, and are held at the top of queue 65. Next in rank are topic requests 49 of topics requested by someone in the users social network, followed by a requested topic that matches the users interests (profile keywords). The ordered queue 65 then supports display of the “Get Inspired to Write” view 21.

Other topic recommendation ranking algorithms are suitable.

In the “Ask for a Content Post” view 23 (FIG. 5), users can request content on a particular topic. Once a request is submitted, users are configured as a subscriber and notified each time entries are later written about their topics. Optionally, requester-users can specify the names or email addresses of other users in order to directly request that those users write about this topic. As the user types the title of the topic he/she is requesting, system 100 in one embodiment provides auto-complete functionality in order to reduce the appearance of duplicate topic requests 49 in the system. If the requester-user selects an existing topic from the auto-complete box, a vote (through voting mechanism 41) is submitted for that topic request 49. A requester-user can also see topic requests 49 that he has previously requested from this view 23, in order to see how many additional votes those topic requests have accumulated or to refind an entry written about a topic he requested.

As previously mentioned, in one embodiment, the user-requester is configured as a subscriber to the topic request 49 that he has submitted in system 100. Similarly when a user votes on topic request 49, system 100 configures that user as a subscriber to the topic request 49. Then, when a target or other user responds to that topic request 49 by uploading content, system 100 issues a notification to all such subscribers (the requester-user and any voter users). The notification may be an email message, alert, or other electronically generated and automated communication.

The topic requests 49 submitted to system 100 are public, and in the “Explore topics & Vote” view 25 (FIG. 6). There, users can serendipitously discover topics to write about through browsing lists showing recent, popular, or topics within a user's social network. Users can also let potential content writers know that they would be interested in reading about a topic through voting 41. As with submitting a topic request 49, when a user votes on a topic, system 100 notifies her each time someone publishes content about it.

Throughout the interface 55, the number of reader users (including the original requester user) interested in a topic is shown next to a star icon 43, for example. Clicking on the “details” link 45 (hypertext or similar) shows the complete list of users who have voted for or requested this topic, as well as any entries written about it. Hyperlinks to the entries/uploaded content in response to the topic request 49 may be included in the “details” section as well as in indicators 29 next to the topic request 49.

Furthermore in Explore Topics & Vote tab 25 (FIG. 6), users are given the option of “Recommending to Others.” If a user discovers a topic that she thinks someone else should write about or is knowledgeable about, she can recommend the topic to them directly by entering their names or email addresses. Finally, a user can also see actual recommendations 49 that were made to her social network. Users are given the option of voting on these if they think they are a good match for their co-workers (e.g. “Vote: I′d like Luis to write this!”). Similar to voting on requested topics, this will increase the “reader” star count 43 on this topic. In addition, system 100 also notifies the recipient person in the social network of a user who voted for the recommendation of the recipient that the user would like to read about this topic from her (the recipient).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

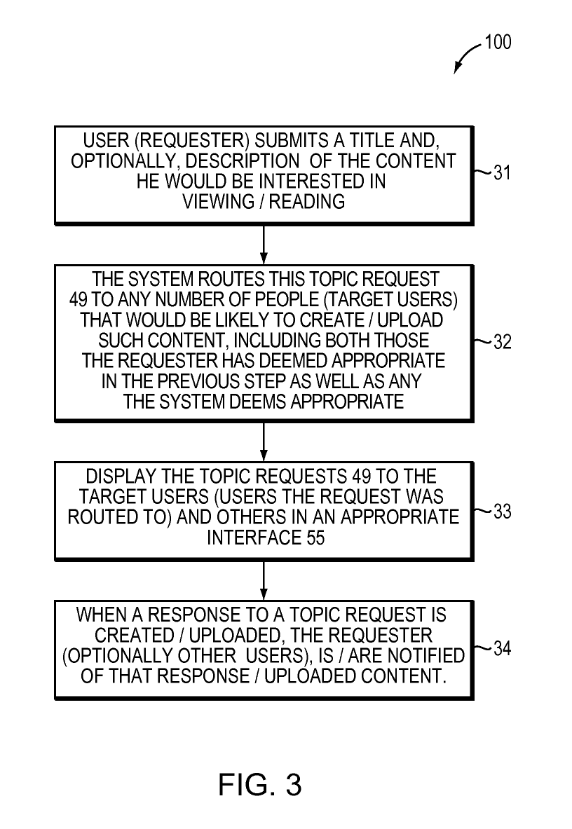

Referring now to FIG. 3, flow of data and control of example system 100 is described.

In Step 31, system 100 (topic requester 53) enables a user (requester) to electronically submit a title of a desired topic and, optionally, a description, indication of proposed media, etc. of the content the requester would be interested in viewing/reading.

In Step 32, the system 100 then routes this request to any number of people (target users) that would be likely to responsively create/upload such content, including both those the requester has deemed appropriate in the previous step as well as any the system 100 deems or otherwise determines appropriate. For example, system 100 may make a keyword determination and user match.

In Step 33, system 100 displays the subject topic requests 49 to the target users (users the request was routed to) in an appropriate interface 55.

In Step 34, when a response to a request 49 is created/uploaded, the system 100 notifies at least the requester of that response (upload and content). System 100 is similarly responsive to each such response and for each such requester/voter of the topic/topic request 49.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

For example, one embodiment may fully or semi-automate the topic request process if integrated within a search functionality. When a user performs a search on a web site and finds no matching content, the system 100 automatically formulates and submits a topic request 49 based on the subject search terms. Or if the user indicates that the search results did not contain what he was looking for, system 100 automatically submits, (generates and routes) a topic request 49 through user interface 55 as described above.

In another example, the foregoing describes requested and uploaded content as being viewable to users. However various forms of content are contemplated including audio or audible content. Thus as used herein, content being “viewable”, “readable”, etc., to a user in this context also extends to being audible.

What is claimed is:

1. A computer-based method of audience suggested content creation in social media comprising:
in a computer network, obtaining a topic request submitted by a requester user, the topic request indicating a topic for content that the requester user is interested in viewing;
using a processor, routing the topic request to any number of target users that would be likely to responsively create such content including any users that the requester user has indicated;
displaying the topic request to the target users in an interface operatively coupled to the processor; and
notifying at least the requester user at each instance of content being uploaded to the computer network in a response to the topic request.

2. A method as claimed in claim 1, wherein the topic request as submitted by the requester user includes any combination of: a title of the topic, a description of the topic and an indication of media for the requested content.

3. A method as claimed in claim 1, wherein the uploaded content in response to the topic request is viewable by other users in addition to the requester-user, the uploaded content being uploaded to a non-private medium and in a non-individual user targeted communication.

4. A method as claimed in claim 1, wherein the uploaded content in response to the topic request is any of a blog entry, a bookmark in a shared online bookmarking system, a Wiki, a web page entry, a web page posting and an online video posting.

5. A method as claimed in claim 1, wherein the uploaded content in response to the topic request is uploaded by a target user to a social media system of the target user's choosing.

6. A method as claimed in claim 1, wherein the requester user indicates target users by any of: individual name, occupation title and part of a social network.

7. A method as claimed in claim 1, wherein multiple different content by different users are uploaded in response to the topic request, and for each content upload, at least the requester user is notified.

8. A method as claimed in claim 1, further comprising:
enabling a user in the computer network to vote on the topic request; and
the step of notifying includes notifying each voter user of each instance of content uploaded in response to the topic request.

9. A method as claimed in claim 8, wherein displaying includes indicating a total number of users interested in the topic request, the total number being a sum of voter users and requester user of the topic request.

10. A method as claimed in claim 8, wherein displaying includes any of:
enabling a user to selectably see details about a voter user's interest in the topic request; and
indicating an individual voter user's stated interest in a certain recipient responding to the topic request.

11. A method as claimed in claim 1, wherein displaying includes indicating to a given target user one or more reasons why the topic request was routed to him.

12. A method as claimed in claim 1, further comprising: enabling other users to view the topic request without having routed the topic request to the other users.

13. A method as claimed in claim 1, further comprising: enabling target users and other users of the computer network to forward the topic request to one or more users.

14. A method as claimed in claim 1, further comprising:
enabling a target user to see the topic request routed to his social network; and
enabling that target user to indicate which individuals in his social network are likely to respond to the topic request.

15. A computer network content suggestion system, comprising:
a topic requester executable in a computer network, and obtaining a topic request submitted by a requester user, the topic request indicating a topic for content that the requester user is interested in viewing;
a processor coupled to the topic requester and configured to route the topic request to any number of target users that would be likely to responsively create such content including any users that the requester user has indicated; and
a user interface operatively coupled to the processor, the user interface configured to display the topic request at least to the target users, wherein at each instance of content in response to the topic request being uploaded to the computer network, the processor notifying at least the requester user.

16. A computer system as claimed in claim 15, wherein the topic request as submitted by the requester user includes any combination of: a title of the topic, a description of the topic and an indication of media for the requested content.

17. A computer system as claimed in claim 15, wherein the uploaded content in response to the topic request is viewable by other users in addition to the requester-user, the uploaded content being uploaded to a non-private medium and in a non-individual user targeted communication.

18. A computer system as claimed in claim 15, wherein the uploaded content in response to the topic request is any of a blog entry, a bookmark in a shared online bookmarking system, a Wiki, a web page entry, a web page posting and an online video posting; and
wherein the uploaded wherein the uploaded content in response to the topic request is uploaded by a target user to a social media system of his choosing.

19. A computer system as claimed in claim 15, wherein the requester user indicates target users by any of: individual name, occupation title, and part of a social network.

20. A computer system as claimed in claim 15, wherein the user interface is further configured to enable a user in the computer network to vote on the topic request; and
the processor is further configured to notify each voter user of each instance of content uploaded in response to the topic request.

21. A computer system as claimed in claim 20, wherein the user interface is further configured to display any combination of:
a total number of users interested in the topic request, the total number being a sum of voter users and requester users of the topic request,
a user selectable area that enables a user to see additional details about a voter user's interest in the topic request; and
an individual voter user's stated interest in a certain user responding to the topic request.

22. A computer system as claimed in claim 15, wherein the user interface is further configured to indicate to a given target user one or more reasons why the topic request was routed to him.

23. A computer system as claimed in claim 15, wherein the user interface is further configured to enable other users to view the topic request without the processor having routed the topic request to the other users.

24. A computer system as claimed in claim 15, wherein the user interface is further configured to enable target users and other users of the computer network to forward the topic request to one or more users.

25. A computer system as claimed in claim 15, wherein the user interface is further configured to enable a target user to see the topic request routed to his social network, and to enable that target user to indicate which individuals in his social network are likely to respond to the topic request.
